(19) United States
(12) Patent Application Publication
(10) Pub. No.: US 2026/0238866 A1
(43) Pub. Date: Aug. 13, 2026

(54) IMAGING DEVICE

(71) Applicant: i-PRO Co., Ltd., Tokyo (JP)

(72) Inventors: Haruhiko KOHNO, Tokyo (JP); Yuichi HATASE, Tokyo (JP); Yoshihito URASHIMA, Tokyo (JP)

(73) Assignee: i-PRO Co., Ltd., Tokyo (JP)

(21) Appl. No.: 19/153,488

(22) PCT Filed: Jan. 16, 2024
(86) PCT No.: PCT/JP2024/000996

§ 371 Date: Aug. 4, 2025

(30) Foreign Application Priority Data
Feb. 3, 2023 (JP) 2023-015429

(51) Int. Cl. H04N 23/52; G03B 17/55; H04N 23/51; H04N 23/54; H04N 23/55

(52) U.S. Cl. CPC H04N 23/52; G03B 17/55; H04N 23/51; H04N 23/54; H04N 23/55

(57) ABSTRACT

An imaging device that achieves both improvement in heat dissipation efficiency and downsizing. An imaging device according to the present invention includes a first substrate including a first mounting surface on which an imaging element is mounted, a second substrate including a second mounting surface on which a processing module configured to process an output signal of the imaging element is mounted, a lens unit configured to guide light to the imaging element, and a housing accommodating the first substrate, the second substrate, and the lens unit. The first substrate is disposed such that the first mounting surface intersects an optical axis direction. The second substrate is disposed such that the second mounting surface intersects the optical axis direction, and a gap is present between the second substrate and the first substrate along the optical axis direction.

### TECHNICAL FIELD

The present invention relates to an imaging device.

### BACKGROUND ART

For an imaging device that forms an image from light collected by a lens with an imaging element, a technique for dissipating heat of the imaging device is known (for example, see Patent Documents 1 and 2).

### CITATION LIST

### Patent Literature

### Patent Document 1: JP 2020-065958 A

### Patent Document 2: JP 2017-040723 A

### SUMMARY OF INVENTION

### Technical Problem

In the imaging device of Patent Document 1, a substrate to which a heat-sensitive imaging element is mounted and a substrate to which a component that generates a large amount of heat is mounted are separated from each other, but there is room for improvement in the placement of the respective substrates from a viewpoint of downsizing the imaging device. Similarly, in the imaging device of Patent Document 2, in order to downsize the imaging device, it is necessary to devise the placement of a substrate to which a heat-sensitive imaging element is mounted and a substrate to which a component that generates a large amount of heat is mounted.

The present invention has been made in view of the above circumstances, and an object thereof is to provide an imaging device that achieves both improvement in heat dissipation efficiency and downsizing.

### Solution to Problem

### Invention 1

In order to solve the above-described problem, an imaging device according to the present invention includes: a first substrate including a first mounting surface on which an imaging element is mounted; a second substrate including a second mounting surface on which a processing module configured to process an output signal of the imaging element is mounted; a lens unit configured to guide light to the imaging element; and a housing accommodating the first substrate, the second substrate, and the lens unit. The first substrate is disposed such that the first mounting surface intersects an optical axis direction. The second substrate is disposed such that the second mounting surface intersects the optical axis direction, and a gap is present between the second substrate and the first substrate along the optical axis direction.

In addition, as preferred aspects of the present invention, the following configurations can be exemplified.

### Invention 2

The imaging device according to Invention 1 above, in which the first substrate includes a heat transfer pattern through which heat generated on the first mounting surface is released.

### Invention 3

The imaging device according to Invention 2 above, in which the heat transfer pattern is provided around the imaging element on the first mounting surface.

### Invention 4

The imaging device according to Invention 1 above, in which the housing includes a lens unit case retaining the lens unit, and the lens unit case is in thermal contact with the first mounting surface.

### Invention 5

The imaging device according to Invention 1 above, including a flexible conductive member connecting the first substrate and the second substrate.

### Invention 6

The imaging device according to Invention 1 above, in which a heat generation amount of the second substrate is larger than a heat generation amount of the first substrate.

### Invention 7

The imaging device according to Invention 1 above, in which the processing module has a function of converting a parallel signal of the imaging element into a serial signal, and transmitting the serial signal.

### Invention 8

The imaging device according to Invention 1 above, including a cable through which a signal is output to an external device, in which the cable is connected to the second substrate, and heat of the second substrate is released to an outside via the cable.

### Invention 9

The imaging device according to Invention 8 above, in which the second mounting surface includes a connection port connecting with the cable, and a heat transfer pattern through which heat generated on the second mounting surface is released, the heat transfer pattern being provided around the connection port.

### Invention 10

The imaging device according to Invention 1 above, including a spacer member for maintaining the gap.

### Invention 11

The imaging device according to Invention 10 above, in which the first substrate and the second substrate have a disk shape.

### Invention 12

The imaging device according to Invention 11 above, in which one end side of the spacer member is engaged with a first notch portion provided at a peripheral edge portion of the first substrate, and the other end side is in contact with the second substrate.

### Invention 13

The imaging device according to Invention 12 above, including a positioning member positioning the second substrate relative to the first substrate in a circumferential direction, in which the positioning member engages with a second notch portion provided at a peripheral edge portion of the first substrate and a third notch portion provided at a peripheral edge portion of the second substrate.

### Invention 14

The imaging device according to Invention 1 above, including a bracket retaining the housing, in which the bracket is in thermal contact with the housing.

### Invention 15

The imaging device according to Invention 1 above, in which the first substrate and the second substrate are disposed such that a surface of the first substrate on an opposite side to the first mounting surface, and a surface of the second substrate on an opposite side to the second mounting surface face each other.

### Advantageous Effects of Invention

According to the present invention, an imaging device that achieves both improvement in heat dissipation efficiency and downsizing can be provided. Problems, configurations, and effects other than those described above will be clarified by the description of embodiments below.

### BRIEF DESCRIPTION OF DRAWINGS

FIG. 1 is an explanatory diagram illustrating a configuration of a head-separated camera.

FIG. 2 is an exploded perspective view of a camera head.

FIG. 3 is a longitudinal cross-sectional view of the camera head.

FIG. 4 is an exploded perspective view of an imaging unit.

FIG. 5 is an exploded perspective view of the imaging unit.

FIG. 6 is an external perspective view of the imaging unit.

FIG. 7 is an external perspective view of the imaging unit.

FIG. 8 is a side view of a substrate unit.

FIG. 9 is an exploded perspective view of a leading end portion of the camera head.

FIG. 10 is an explanatory diagram of an air layer in a front case.

FIG. 11 is a front view of an LED substrate.

FIG. 12 is a perspective view illustrating a longitudinal cross-sectional view of the camera head.

FIG. 13 is an explanatory diagram illustrating heat generation sources of the head-separated camera.

FIG. 14 is an explanatory diagram illustrating heat transfer of the camera head.

FIG. 15 is a longitudinal cross-sectional view of a camera head according to a second embodiment.

FIG. 16 is an explanatory diagram illustrating heat transfer of the camera head according to the second embodiment.

FIG. 17 is a longitudinal cross-sectional view of a camera head according to a third embodiment.

FIG. 18 is an explanatory diagram illustrating heat transfer of the camera head according to the third embodiment.

FIG. 19 is an explanatory diagram illustrating a sensor substrate and a signal transmission substrate according to a modification.

### DESCRIPTION OF EMBODIMENTS

Hereinafter, embodiments of the invention will be described with reference to the drawings. The embodiments contribute to “9. Basis of Industry and Technical Innovation” of Sustainable Development Goals (SDGs) proposed by the UN by realizing an imaging device that achieves both improvement in heat dissipation efficiency and downsizing.

### First Embodiment

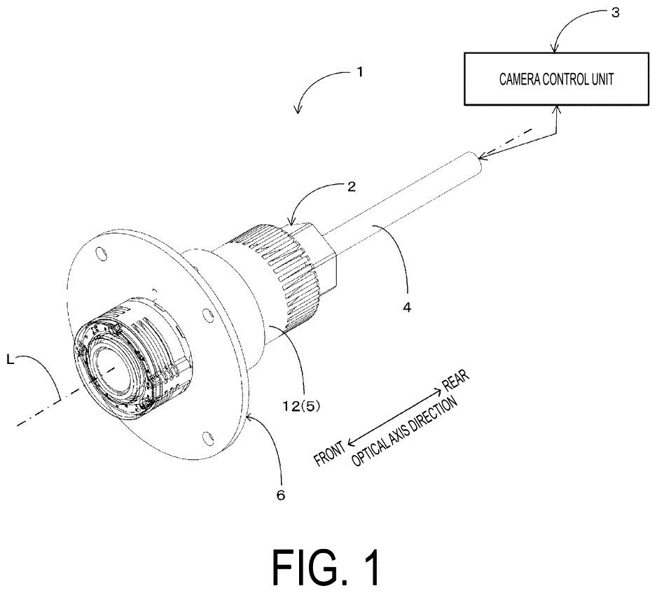

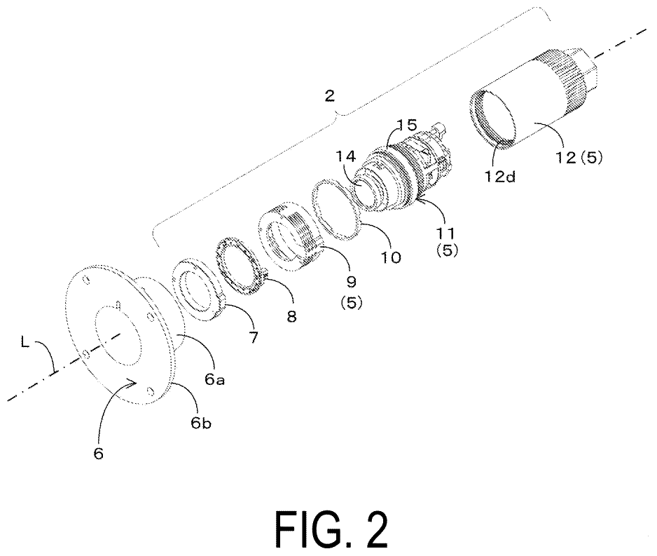

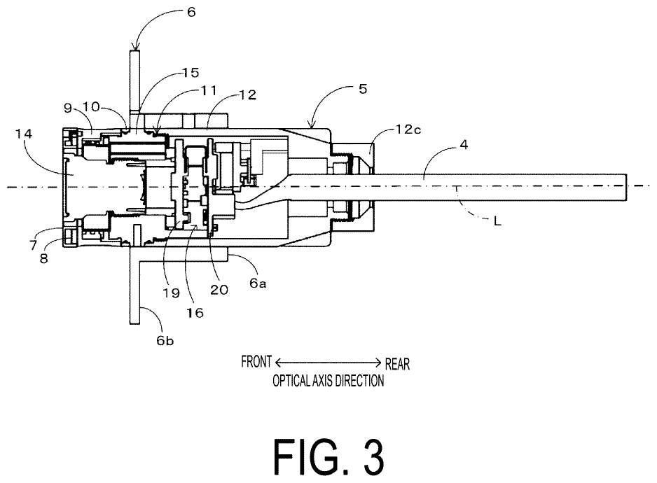

FIG. 1 is an explanatory diagram illustrating a configuration of a head-separated camera 1, FIG. 2 is an exploded perspective view of a camera head 2, and FIG. 3 is a longitudinal cross-sectional view of the camera head 2. In FIGS. 1 to 3, a reference sign L indicates an optical axis. As illustrated in FIGS. 1 to 3, the head-separated camera 1 includes the camera head 2, a camera control unit 3, and a cable 4. The cable 4 connects the camera head 2 and the camera control unit 3. The camera control unit 3 controls the camera head 2. The camera head 2 is an example of an imaging device.

In the present specification, for convenience of description, a direction toward an upstream side in a travel direction of light incident on the camera head 2 is defined as a front side, and a direction toward a downstream side is defined as a rear side. That is, the left direction in FIG. 3 corresponds to the front side, and the right direction in FIG. 3 corresponds to the rear side. Thus, one end out of both end portions of the camera head 2 closer to a subject is the front end of the camera head 2, and the other end farther from the subject is the rear end of the camera head 2.

In the present specification, the term “in thermal contact” is used to mean a state in which the heat of one member can be transferred to another member. For example, when metal members are in a state of being in physical contact with each other and the heat of one metal member can be transferred to the other metal member, this state is a state of being in thermal contact with each other. When members are in contact with each other via a heat transfer member and heat can be transferred from one member to the other member via the heat transfer member, this state is also a state of being in thermal contact with each other. Further, when heat can be transferred between members, the members are in thermal contact with each other even when the members are not in physical contact with each other. For example, when members are disposed with a slight gap therebetween and the heat of one member can be transferred to the other member through the gap, both members are in thermal contact with each other also in this state. On the other hand, even in a state in which members are in physical contact with each other, when heat cannot be transferred between the members, the members are not in thermal contact with each other.

The camera head 2 includes a housing 5. The housing 5 is a casing that accommodates optical components and electrical components of the camera head 2 described below. The housing 5 can be attached to a bracket 6. The bracket 6 retains the housing 5.

The bracket 6 includes a tubular portion 6a having a cylindrical shape and a flange 6b. The housing 5 is inserted into the tubular portion 6a. In a state in which the housing 5 is inserted into the tubular portion 6a, a screw (not illustrated) is inserted into a screw hole provided in the tubular portion 6a, whereby the housing 5 is fixed to a predetermined position of the bracket 6. The tubular portion 6a of the bracket 6 and the housing 5 are metals and are in thermal contact with each other. Accordingly, the heat of the housing 5 can be released to the outside of the camera head 2 (e.g., the atmosphere) via the bracket 6.

The camera head 2 includes an LED cover 7, an LED substrate 8, a front case 9, a heat insulating ring 10, an imaging unit 11, and a rear case 12. The LED cover 7, the LED substrate 8, the front case 9, the heat insulating ring 10, the imaging unit 11, and the rear case 12 are arranged side by side on the optical axis L.

The imaging unit 11 includes a lens unit 14 and a lens unit case 15 that accommodates the lens unit 14. The housing 5 has a cylindrical shape as a whole, and includes the front case 9, the lens unit case 15, and the rear case 12. The front case 9, the lens unit case 15, and the rear case 12 are made of a nonferrous metal material having a high thermal conductivity, for example, aluminum.

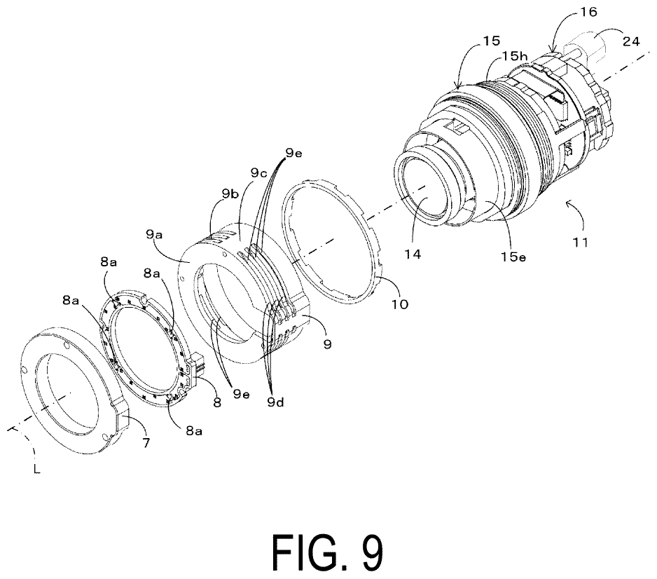

The front case 9 has a cylindrical shape and is screwed to the lens unit case 15 via the heat insulating ring 10 (see FIG. 9). Accordingly, the lens unit case 15 can be easily connected to the front case 9, and transfer of heat between the front case 9 and the lens unit case 15 can be suppressed. Of course, the front case 9 and the lens unit case 15 may be connected by a connection means other than screwing (e.g., fitting). A waterproof packing (not illustrated) is provided at a connection portion between the front case 9 and the lens unit case 15.

The LED substrate 8 has an annular shape. The LED substrate 8 is disposed on the front side of the front case 9 (near the subject) in an optical axis direction of light incident on the lens unit 14.

The LED cover 7 is a transparent member. The LED cover 7 is attached to the front case 9, for example, by welding, and covers the LED substrate 8. Of course, the LED cover 7 may be attached to the front case 9 by another connecting means.

The rear case 12 has a cylindrical shape. The rear case 12 is screwed to the lens unit case 15. Accordingly, the rear case 12 and the lens unit case 15 can be easily connected to each other, and transfer of heat between the rear case 12 and the lens unit case 15 can be suppressed. Of course, the rear case 12 and the lens unit case 15 may be connected by a connection means other than screwing (for example, connection using a cam mechanism, a slide mechanism, or the like, or direct fitting of both). A waterproof packing (not illustrated) is provided at a connection portion between the rear case 12 and the lens unit case 15.

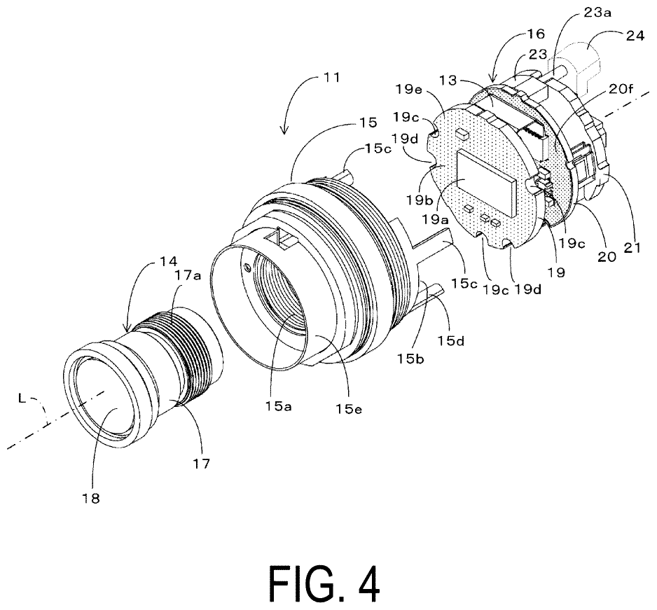

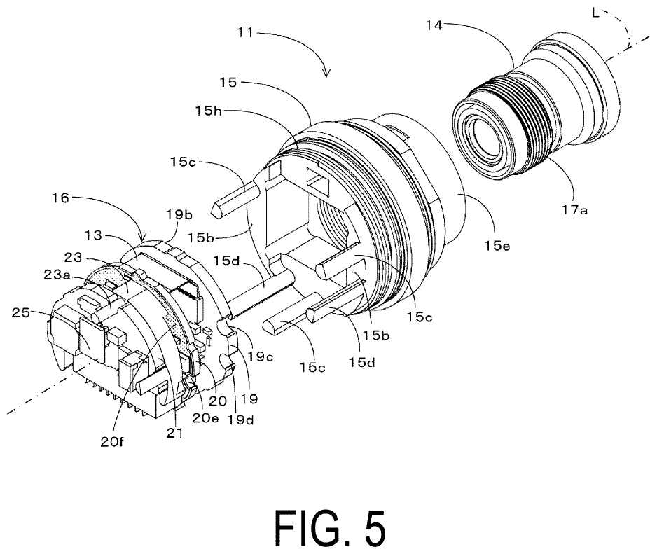

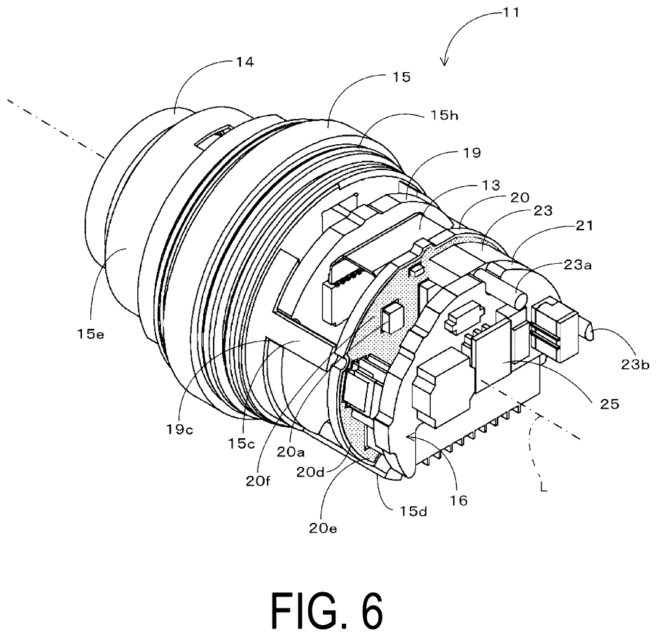

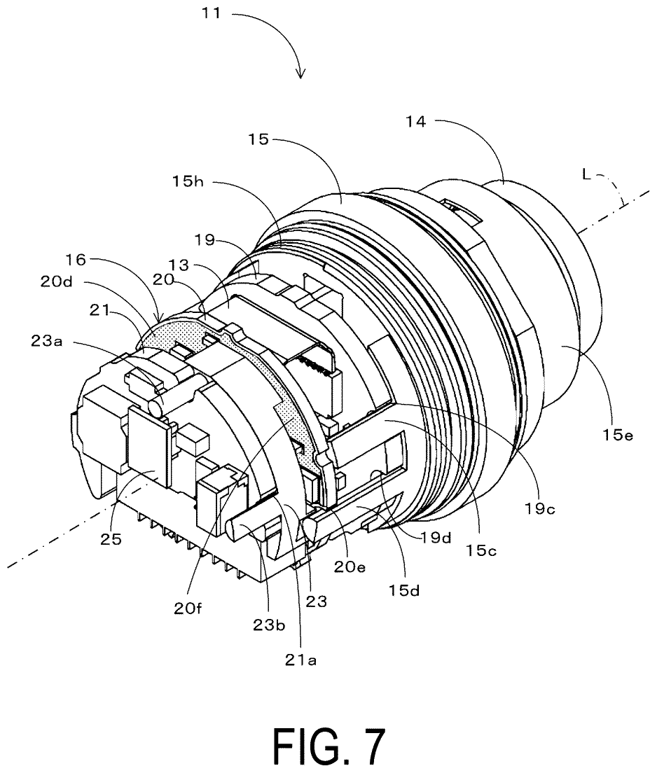

Next, the imaging unit 11 will be described in detail. FIGS. 4 and 5 are exploded perspective views of the imaging unit 11, and FIGS. 6 and 7 are external perspective views of the imaging unit 11. As illustrated in FIGS. 4 to 7, the imaging unit 11 includes the lens unit 14, the lens unit case 15, and a substrate unit 16. The lens unit 14, the lens unit case 15, and the substrate unit 16 are arranged side by side on the optical axis L.

The lens unit 14 includes a lens barrel 17 and a lens 18. The lens barrel 17 has a cylindrical shape. The lens barrel 17 accommodates the lens 18.

The lens unit case 15 has a substantially cylindrical shape as a whole. The lens unit case 15 includes an internal thread portion 15a at an inner circumference. The lens barrel 17 includes an external thread portion 17a at an outer circumference. The lens unit case 15 is connected to the lens barrel 17 by screwing the internal thread portion 15a and the external thread portion 17a. Accordingly, the lens unit case 15 accommodates therein the lens unit 14, and restricts the movement of the lens unit 14 in the optical axis direction to retain the lens unit 14 at a predetermined position.

The substrate unit 16 includes a sensor substrate 19, a signal transmission substrate 20, and an LED driver substrate 21. The substrate unit 16 is accommodated in the rear case 12 (see FIGS. 2 and 3).

The sensor substrate 19 is a single-layer substrate having a disk shape. The sensor substrate 19 includes a sensor mounting surface 19b (first mounting surface) on which an imaging element 19a is mounted. The imaging element 19a is, for example, a complementary metal-oxide-semiconductor (CMOS) or a charge-coupled device (CCD).

The sensor mounting surface 19b includes a copper pattern 19e, which is a copper film, around the imaging element 19a. Accordingly, the heat of the sensor substrate 19 is efficiently released via the copper pattern 19e. The copper pattern 19e is an example of a heat transfer pattern.

The lens unit case 15 includes, at a rear end portion thereof, a surface 15b in contact with the copper pattern 19e of the sensor mounting surface 19b. The surface 15b is in contact with the copper pattern 19e around the imaging element 19a so as not to be in contact with the imaging element 19a. In other words, the surface 15b of the lens unit case 15 is in contact with the sensor substrate 19 (the copper pattern 19e) so as to avoid the imaging element 19a. Since the surface 15b is in contact with the copper pattern 19e, the heat generated on the sensor substrate 19 (mainly, on the imaging element 19a) is transferred from the copper pattern 19e to the surface 15b and is released from the lens unit case 15 to the outside of the camera head 2 (e.g., the atmosphere). Thus, temperature rise of the sensor substrate 19 can be suppressed, and an impact of heat on the imaging element 19a can be reduced.

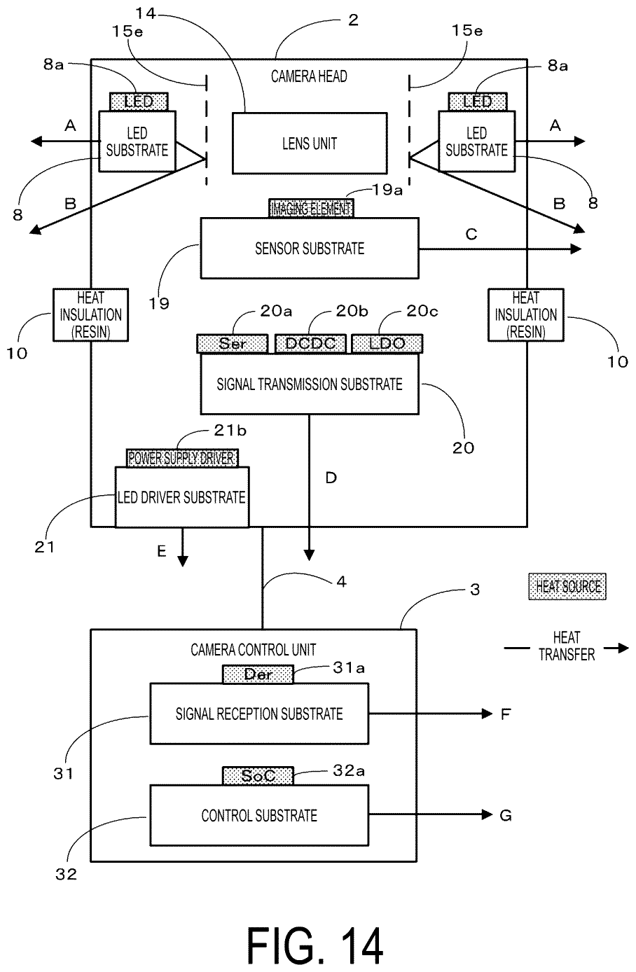

The signal transmission substrate 20 is a single-layer substrate having a disk shape. The signal transmission substrate 20 includes a module mounting surface 20d (the second mounting surface) on which a serializer (Ser) 20a, a DC/DC converter 20b (see FIG. 14), and a low dropout (LDO) regulator 20c (see FIG. 14) are mounted. The sensor substrate 19 and the signal transmission substrate 20 are arranged such that a surface of the sensor substrate 19 on an opposite side to the sensor mounting surface 19b and a surface of the signal transmission substrate 20 on an opposite side to the module mounting surface 20d face each other. That is, the sensor substrate 19 and the signal transmission substrate 20 are erected such that the back surfaces of both the substrates 19 and 20 face each other. With this configuration, the heat generated at the Ser 20a (heat generation amount: large) mounted on the module mounting surface 20d can be suppressed from being transferred to the sensor substrate 19.

The LED driver substrate 21 includes a drive unit that drives LEDs. The LED driver substrate 21 is a single-layer substrate. The LED driver substrate 21 is connected to the LED substrate 8 via a lead wire (not illustrated). The LED driver substrate 21 is an example of a drive substrate.

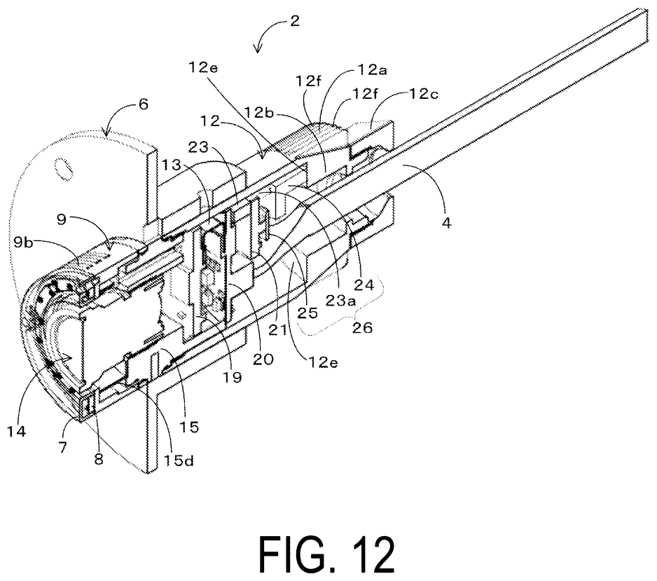

The signal transmission substrate 20 is connected to the camera control unit 3 via the cable 4 (see FIGS. 3 and 12). The signal transmission substrate 20 converts a parallel signal output by the imaging element 19a into a serial signal (processes an output signal), and transmits the serial signal to the camera control unit 3 via the cable 4.

The sensor mounting surface 19b of the sensor substrate 19, the module mounting surface 20d of the signal transmission substrate 20, and a mounting surface of the LED driver substrate 21 are disposed so as to be orthogonal to the optical axis L. In other words, the respective in-plane directions of the sensor substrate 19, the signal transmission substrate 20, and the LED driver substrate 21 are orthogonal to the optical axis direction. The sensor substrate 19, the signal transmission substrate 20, and the LED driver substrate 21 are arranged in this order from the upstream side to the downstream side in the travel direction (incident direction) of light incident on the lens unit 14. The sensor substrate 19, the signal transmission substrate 20, and the LED driver substrate 21 are provided at intervals (i.e., separated) from each other in the optical axis direction. The respective mounting surfaces of the sensor substrate 19, the signal transmission substrate 20, and the LED driver substrate 21 are not necessarily orthogonal to the optical axis direction, and the respective mounting surfaces only need to intersect the optical axis direction to the extent that the mounting surfaces are substantially orthogonal to the optical axis direction.

The sensor substrate 19 is an example of a first substrate. The signal transmission substrate 20 is an example of a second substrate. The signal transmission substrate 20 is an example of a processing module.

The lens unit case 15 includes a spacer member 15c and a positioning member 15d. The spacer member 15c and the positioning member 15d are rod-shaped members extending toward the downstream side in the travel direction of light incident on the lens 18 from the lens unit case 15, that is, toward the rear side. The positioning member 15d is a member longer than the spacer member 15c in an axial direction.

The sensor substrate 19 includes notches 19c and 19d at a peripheral edge portion. The signal transmission substrate 20 includes a notch 20e at peripheral edge portion. The notch 19c is a recess having a shape into which the spacer member 15c is fitted. The notches 19d and 20e are recesses having a shape into which the positioning member 15d is fitted.

For example, as illustrated in FIG. 6, the spacer member 15c engages with the notch 19c and is in contact with a back surface of the module mounting surface 20d of the signal transmission substrate 20 (i.e., a surface of the signal transmission substrate 20 facing the sensor substrate 19). In this way, the spacer member 15c is fixed to the sensor substrate 19. The spacer member 15c may be fixed to the sensor substrate 19 via an adhesive filling between the spacer member 15c and the notch 19c. The spacer member 15c is in contact with the signal transmission substrate 20 in a state in which a certain distance is maintained between the sensor substrate 19 and the signal transmission substrate 20 in the optical axis direction, thereby positioning the signal transmission substrate 20 relative to the lens unit case 15 in the optical axis direction.

As illustrated in FIG. 7, the positioning member 15d is a member that extends to the rear side of the signal transmission substrate 20 and is longer than the spacer member 15c in the axial direction. The positioning member 15d engages with the notch 19d of the sensor substrate 19 and also engages with the notch 20e of the signal transmission substrate 20. In this way, the positioning member 15d is fixed to the sensor substrate 19 and the signal transmission substrate 20. The positioning member 15d may be fixed to the sensor substrate 19 and the signal transmission substrate 20 by an adhesive filling between the positioning member 15d and the notch 19d and between the positioning member 15d and the notch 20e. The positioning member 15d engages with the notch 19d and the notch 20e, thereby positioning the sensor substrate 19 and the signal transmission substrate 20 in a circumferential direction of the housing 5.

The notch 19c is an example of a first notch portion provided at the first substrate. The notch 19d is an example of a second notch portion provided at the first substrate. The notch 20e is an example of a third notch portion provided at the second substrate.

Here, the signal transmission substrate 20 is indirectly in contact with the lens unit case 15 via the spacer member 15c and the positioning member 15d. That is, the signal transmission substrate 20 is not in physical contact with the lens unit case 15. The signal transmission substrate 20 is not in physical contact with the rear case 12. Thus, the heat of the signal transmission substrate 20 can be prevented from being transferred to the lens unit case 15 and the rear case 12. The heat of the signal transmission substrate 20 can be reliably released to the outside of the camera head 2, for example, to the atmosphere via the cable 4. That is, in the first embodiment, the heat of the signal transmission substrate 20 can be released from the cable 4 to the atmosphere without being transferred to the housing 5.

The signal transmission substrate 20 includes, on both surfaces thereof, a copper pattern 20f which is a copper foil. In particular, the copper pattern 20f is formed around a connection port of the cable 4 at the module mounting surface 20d. Accordingly, the heat dissipation effect of the signal transmission substrate 20 can be increased. More specifically, the heat generated on the module mounting surface 20d is released by convection or radiation via the copper pattern 20f, whereby the heat dissipation effect of the signal transmission substrate 20 is increased.

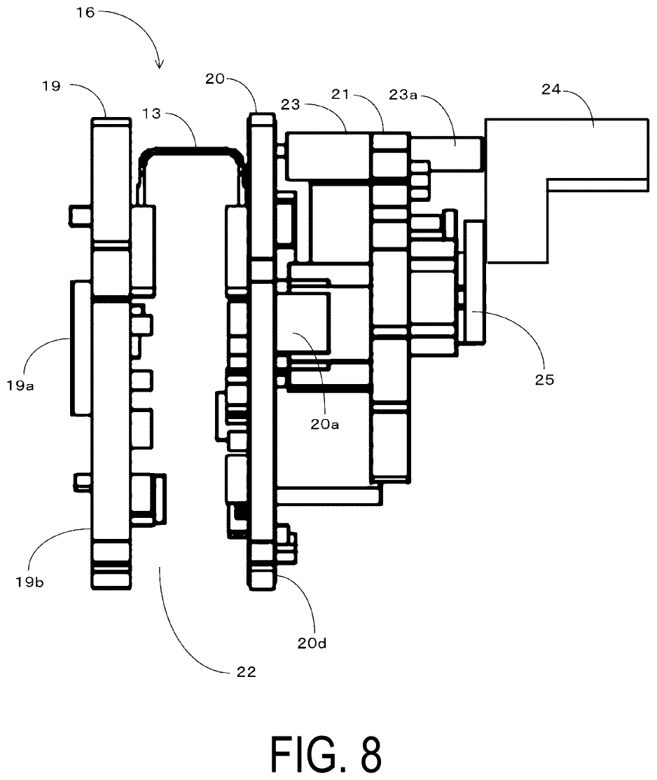

Next, the substrate unit 16 will be described in detail. FIG. 8 is a side view of the substrate unit 16. As illustrated in FIG. 8, the sensor substrate 19 is connected to the signal transmission substrate 20 via a flexible printed circuit (FPC) 13 which is a heat insulating member. The FPC 13 is an example of a flexible conductive member. As described above, a certain distance is maintained between the sensor substrate 19 and the signal transmission substrate 20 via the spacer member 15c in the optical axis direction. Thus, there is an air gap 22 between the sensor substrate 19 and the signal transmission substrate 20.

Since air has a lower thermal conductivity than the copper pattern, the air gap 22 functions as a heat insulating member. In other words, the air gap 22 is a heat insulation layer for preventing the heat of the signal transmission substrate 20 from being transferred to the imaging element 19a and the lens unit 14. The heat generated on the signal transmission substrate 20 is released to the atmosphere mainly via the cable 4. On the other hand, the heat generated on the sensor substrate 19 is released to the outside of the camera head 2 (e.g., the atmosphere) mainly via the lens unit case 15 (further via the bracket 6). In this way, in the first embodiment, the heat of the sensor substrate 19 and the heat of the signal transmission substrate 20 are efficiently released without being transferred to each other.

For example, the air gap 22 is 5 mm, the length of the FPC 13 is 13 mm, and the diameter of each of the sensor substrate 19 and the signal transmission substrate 20 is 20 mm.

In the first embodiment, the sensor substrate 19 and the signal transmission substrate 20 are separated from each other, and are not formed as one collective substrate. The sensor substrate 19 is arranged coaxially with the signal transmission substrate 20 via the air gap 22 in the optical axis direction. The in-plane direction of the sensor substrate 19 and the in-plane direction of the signal transmission substrate 20 are orthogonal to the optical axis direction. Thus, it is possible to achieve both improvement in heat dissipation efficiency and downsizing of the camera head 2. In addition, the projection size of the camera head 2 from an imaging direction can be reduced.

In the camera head 2, the sensor substrate 19 and the signal transmission substrate 20 are separate substrates and are arranged in the optical axis direction. Thus, the diameter of the camera head 2 can be reduced when viewed from the optical axis direction, as compared to a configuration in which the substrates are integrated into one. For example, the length of the camera head 2 in the optical axis direction is about 60 mm to 70 mm.

Next, the leading end portion of the camera head 2 will be described in detail. FIG. 9 is an exploded perspective view of the leading end portion of the camera head 2. As illustrated in FIG. 9, the front case 9 includes a body 9c having a cylindrical shape and a contact surface 9a with which the LED substrate 8 is in contact. The contact surface 9a is provided at an end portion of the body 9c on the front side in the optical axis direction.

The front case 9 includes a heat sink 9b. The heat sink 9b includes a plurality of fins 9d (fin portions) and a plurality of slits 9e (hole portions). The fins 9d and the slits 9e are intermittently provided at a circumferential surface of the body 9c. The fins 9d and the slits 9e extend along the circumferential direction. The fins 9d and the slits 9e are provided at four locations along the circumferential direction, respectively.

With this configuration, the heat generated on the LED substrate 8 is transferred to the front case 9 via the contact surface 9a and is released via the heat sink 9b. In addition, since air inside the front case 9 is exchanged (ventilated) with air outside the front case 9 via the plurality of slits 9e, the lens unit 14 accommodated in the front case 9 can be prevented from becoming high temperature. Further, since the front case 9 is connected to the lens unit case 15 via the heat insulating ring 10, the heat of the LED substrate 8 can be prevented from being transferred to the lens unit case 15. With this configuration, the length of the front case 9 in the axial direction can be reduced as compared to a heat sink having a structure in which fins extend along the optical axis direction.

Instead of the slits 9e, a mesh, punch holes, or the like may be employed. That is, the heat sink 9b needs to include hole portions, and slits, a mesh, or punch holes can be appropriately employed as the hole portions. In addition, slits, a mesh, and punch holes may be used alone or in combination. The shape of the slits, the shape of the mesh, and the shape of the punch holes may be any shapes. The heat sink 9b may include only the plurality of slits 9e (hole portions) without including the plurality of fins 9d as fin portions.

The front case 9 accommodates a front part of the lens unit case 15 and physically protects the lens unit 14. The lens unit case 15 includes a partition wall portion 15e having a thin cylindrical shape that is disposed on an outer circumferential side of the lens unit 14 and wholly surrounds the lens unit 14. The partition wall portion 15e is made of a metal material. The partition wall portion 15e is not coated. With this configuration, radiation heat transfer from the heat sink 9b can be prevented as much as possible. That is, heat transfer from the heat sink 9b to the lens unit 14 can be suppressed.

The partition wall portion 15e extends forward from a front end portion of the lens unit case 15. Specifically, the partition wall portion 15e extends from the front end portion of the lens unit case 15 to a position close to, but not in contact with the inside of the contact surface 9a of the front case 9. Accordingly, the flow of air inside the front case 9 is not hindered, and the heat dissipation effect can be suitably maintained. In addition, the heat from the LED substrate 8 can be prevented from being transferred to the partition wall portion 15e. The partition wall portion 15e partitions an annular space between the front case 9 and the lens unit 14 in a radial direction (a direction orthogonal to the optical axis direction) in a state in which the front case 9 is attached to the lens unit case 15, thereby forming two air layers 15f and 15g described below.

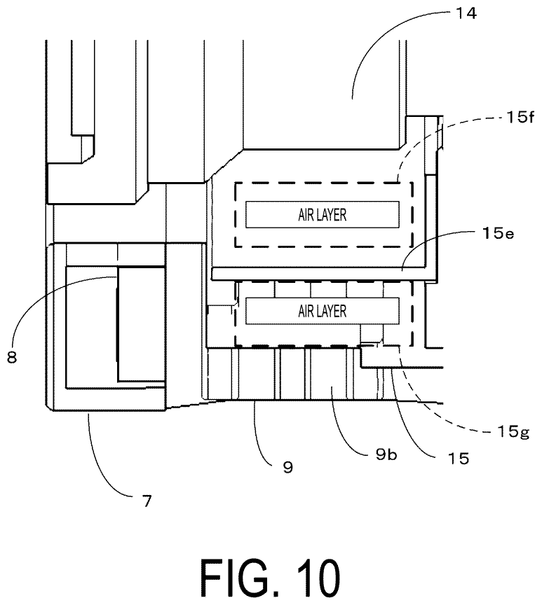

FIG. 10 is an explanatory diagram of the air layers 15f and 15g in the front case 9, and illustrates a part of a longitudinal cross-section of the leading end portion of the camera head 2. As illustrated in FIG. 10, in a state in which the lens unit 14 is accommodated in the lens unit case 15 and the front case 9 is attached to the lens unit case 15, the air layer 15f partitioned by the partition wall portion 15e is formed around the lens unit 14. In addition, the air layer 15g partitioned by the heat sink 9b is formed around the partition wall portion 15e. In this way, the two air layers 15g and 15f are interposed between an inner circumferential surface of the front case 9 and the lens unit 14 via the partition wall portion 15e. Accordingly, heat transfer from the heat sink 9b to the lens unit 14 can be prevented by the heat insulating effect of the air layers 15g and 15f.

More specifically, although the heat generated on the LED substrate 8 is transferred to the heat sink 9b via the contact surface 9a, the air layers 15g and 15f can prevent the heat of the LED substrate 8 from being transferred to the lens unit 14. Thus, the temperature rise of the lens 18 is suppressed, and the deterioration of the lens 18 (for example, deformation due to heat or focus deviation due to thermal expansion) is prevented. Further, since a sufficient heat insulating effect can be obtained only by providing the partition wall portion 15e having a thin cylindrical shape, the diameter of the camera head 2 does not become large. In this way, the front case 9 dissipates the heat generated on the LED substrate 8 to the surrounding atmosphere to suppress damage to the lens unit 14 and the imaging element 19a due to the heat. The front case 9 retains the LED substrate 8 at a position at which unnecessary illumination light does not leak into the lens unit 14. That is, the front case 9 of the present embodiment can achieve both suppression of deterioration of the lens 18 and downsizing of the camera head 2.

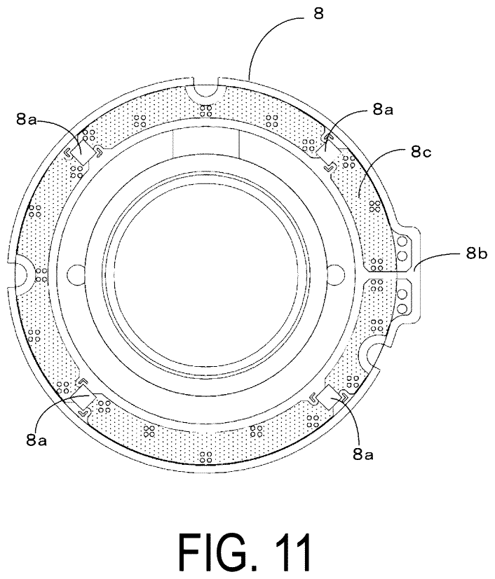

Next, the LED substrate 8 will be described in detail. FIG. 11 is a front view of the LED substrate 8. As illustrated in FIG. 11, the LED substrate 8 includes a plurality of light emitting members, for example, four LEDs 8a. The LED 8a emits light that passes through the LED cover 7 to the outside. The size of the LED 8a is, for example, 1.6 mm×2.0 mm.

A copper pattern 8c, which is a thin copper film, is provided at the mounting surface of the LED 8a of the LED substrate 8. The LED substrate 8 is a substrate including multiple layers each of which includes the copper pattern 8c.

The heat of the LED 8a is released to air inside the LED cover 7 via the copper pattern 8c, and is transferred to the heat sink 9b via the contact surface 9a of the front case 9. Then, the heat is released to the outside of the camera head 2 (e.g., the atmosphere) via the heat sink 9b. With this configuration, the heat of the LED 8a is efficiently released to the outside of the camera head 2.

The LED substrate 8 includes a connector mounting portion 8b that protrudes outward in the radial direction from a peripheral edge portion (for example, protrudes by 1.25 mm). A connector mounted at the connector mounting portion 8b is connected to a connector mounted at the LED driver substrate 21 via a lead wire (not illustrated).

The diameter of the LED substrate 8 is 24 mm, for example. The width of the LED substrate 8 including the connector mounting portion 8b is 25.3 mm, for example.

The four LEDs 8a are provided at intervals from each other at positions overlapping with (corresponding to) the positions of the fins 9d and the positions of the slits 9e of the heat sink 9b in the circumferential direction of the front case 9 when viewed from the optical axis direction. Thus, the camera head 2 can efficiently release the heat generated at the LEDs 8a from the heat sink 9b to the atmosphere. Accordingly, the camera head 2 can prevent the heat of the LED substrate 8 from being transferred to the lens unit 14 and the imaging element 19a.

Next, the rear case 12 will be described in detail. FIG. 12 is a perspective view illustrating a longitudinal cross-sectional view of the camera head 2. As illustrated in FIG. 12, the rear case 12 has a cylindrical shape. The rear case 12 includes a heat sink 12a at a rear end portion of an outer circumferential surface of the rear case 12. The heat sink 12a includes a plurality of fins 12f parallel to the optical axis direction. The fins 12f are disposed at equal intervals along the circumferential direction at the circumferential surface of the rear case 12. By forming the fins 12f in parallel with the optical axis direction, the heat of the rear case 12 can be efficiently released. The fins 12f do not protrude from the outer circumferential surface of the rear case 12 when viewed from the optical axis direction. That is, when the rear case 12 is viewed from the optical axis direction, the diameter of a circle that is centered on the optical axis L and circumscribed around the respective apex portions of the plurality of fins 12f is substantially the same as the diameter of the rear case 12.

Here, the arrangement direction of the fins 12f is not necessarily parallel to the optical axis direction. For example, the arrangement direction of the fins 12f may be the circumferential direction of the rear case 12, or may be a direction intersecting the optical axis direction. The shape of the fin 12f is arbitrary. For example, the shape may be a shape (pillar shape) protruding from the outer circumferential surface of the rear case 12.

The rear case 12 includes, at the inner circumferential surface thereof, a protruding portion 12b extending toward the optical axis L. The protruding portion 12b is a thick annular step portion formed at the inner circumferential surface of the rear case 12. The protruding portion 12b is provided at the rear end portion of the rear case 12. The protruding portion 12b and the heat sink 12a are located at substantially the same position in the optical axis direction, and the protruding portion 12b is located on the inner circumferential side of the heat sink 12a. Thus, the heat transferred to the protruding portion 12b can be released from the protruding portion 12b to the outside of the camera head 2 (e.g., the atmosphere) via the heat sink 12a. The heat sink 12a and the protruding portion 12b are examples of a heat dissipation portion. The heat sink 12a has a shape not protruding from the outer circumference of the rear case 12, and the protruding portion 12b is provided at the inner circumferential surface of the rear case 12. Thus, the camera head 2 can release the heat transferred to the rear case 12 to the atmosphere via the protruding portion 12b and the heat sink 12a, so that the heat dissipation effect can be increased. In addition, by employing a configuration in which heat can be dissipated from the rear case 12, the camera head 2 can be downsized as a whole. That is, the camera head 2 according to the first embodiment can achieve both improvement in heat dissipation efficiency and downsizing.

The rear case 12 includes therein a heat transfer portion 26 in contact with the signal transmission substrate 20 and the protruding portion 12b. The heat transfer portion 26 includes a shaft 23a, a metal member 24, and a heat transfer sheet 25, which will be described below.

A second spacer member 23 is provided between the signal transmission substrate 20 and the LED driver substrate 21 (also see FIGS. 4 to 7). The second spacer member 23 is formed of a resin block body having an arc shape and is attached to the module mounting surface 20d of the signal transmission substrate 20. The second spacer member 23 is in contact with the LED driver substrate 21 to maintain the distance between the signal transmission substrate 20 and the LED driver substrate 21.

One end (front end) of the shaft 23a extending along the optical axis direction is attached to the second spacer member 23. The metal member 24 is attached to the other end (rear end) of the shaft 23a. Accordingly, the metal member 24 is fixed at a predetermined position in contact with an end surface 12e of the protruding portion 12b via the second spacer member 23 and the shaft 23a from the signal transmission substrate 20. The metal member 24 is an L-shaped block body. The metal member 24 is preferably made of a metal material having a high thermal conductivity, and is made of aluminum in the first embodiment, for example.

The metal member 24 is in thermal contact with the mounted components of the LED driver substrate 21 via the heat transfer sheet 25 (see FIG. 8). The heat transfer sheet 25 is a heat transfer member having an insulating property, and has flexibility and adhesiveness. Thus, the heat transfer sheet 25 adheres to the metal member 24 and the mounted components of the LED driver substrate 21. The heat generated at the mounted components of the LED driver substrate 21 is efficiently transferred to the metal member 24 via the heat transfer sheet 25, and is finally released to the outside of the camera head 2 (e.g., the atmosphere) via the protruding portion 12b and the heat sink 12a. Accordingly, the camera head 2 can efficiently dissipate heat via the rear case 12.

In this way, by providing the heat transfer portion 26 inside the rear case 12, the heat dissipation efficiency of the camera head 2 can be increased. Since the fins 12f do not protrude from the outer circumferential surface of the rear case 12 and no auxiliary heat transfer portion such as a fan is provided at the outer circumference of the rear case 12, the camera head 2 can be downsized.

The second spacer member 23 includes a positioning member 23b extending rearward in the optical axis direction (see FIG. 7). The positioning member 23b engages with a notch 21a of the LED driver substrate 21, so that the positioning member 23b is fixed to the LED driver substrate 21. The positioning member 23b may be fixed to the LED driver substrate 21 by fixing the positioning member 23b and the notch 21a with an adhesive. As a result, the LED driver substrate 21 is positioned.

The rear case 12 includes, at an inner circumferential surface of a front portion thereof, an internal thread portion 12d (see FIG. 2). The lens unit case 15 includes an external thread portion 15h (see FIG. 9). The rear case 12 is connected to the lens unit case 15 by screwing the internal thread portion 12d and the external thread portion 15h. The method of connecting the rear case 12 and the lens unit case 15 is not limited to screwing. Another connecting means, for example, a cam mechanism or a slide mechanism may be used, or a means for connecting both members by direct fitting may be used.

When the rear case 12 is rotated relative to (attached to) the lens unit case 15 in a state in which the rear case 12 is fitted into the lens unit case 15, the metal member 24 slides in the circumferential direction while being in contact with the end surface 12e of the protruding portion 12b. When the rear case 12 is completely attached to the lens unit case 15 until the rear case 12 is no longer rotated relative to the lens unit case 15, the metal member 24 and the protruding portion 12b come into thermal contact with each other. In this way, since the metal member 24 is configured to be slidable on the end surface 12e of the protruding portion 12b, the camera head 2 is easily assembled.

A waterproof cap 12c is attached to a rear end portion of the rear case 12. A rubber having a waterproof property is provided inside the waterproof cap 12c. The cable 4 is inserted through the rubber. The rubber fixes the position of the cable 4 at the rear end of the rear case 12.

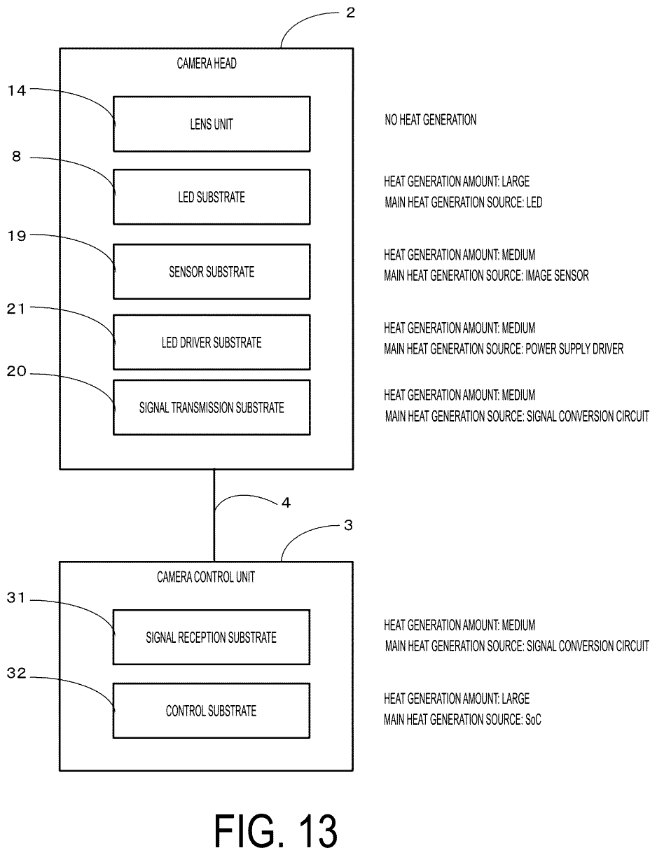

Next, heat generation sources of the head-separated camera 1 will be described. FIG. 13 is an explanatory diagram illustrating heat generation sources of the head-separated camera 1. As illustrated in FIG. 13, in the camera head 2, the lens unit 14 does not generate heat. In the LED substrate 8, the LEDs 8a are main heat generation sources and generate heat. The amount of heat generated by the LED substrate 8 is large (heat generation amount: large). In the sensor substrate 19, the imaging element 19a is a main heat generation source and generates heat. The amount of heat generated by the sensor substrate 19 is smaller than that of the LED substrate 8 (heat generation amount: medium). In the LED driver substrate 21, a power supply driver is a main heat generation source and generates heat. The amount of heat generated by the LED driver substrate 21 is smaller than that of the LED substrate 8 (heat generation amount: medium). In the signal transmission substrate 20, a signal conversion circuit is a main heat generation source and generates heat. The amount of heat generated by the signal transmission substrate 20 is smaller than that of the LED substrate 8 (heat generation amount: medium). The imaging element 19a is greatly affected by heat (for example, noise). Thus, a chip that is a heat generation source is mounted on the signal transmission substrate 20. The heat generation amount of the LEDs 8a varies depending on the illumination intensity of the LED 8a. Therefore, the magnitude relationship between the heat generation amount of the imaging element 19a and the heat generation amount of the LEDs 8a may be reversed.

In the camera control unit 3, a signal conversion circuit is a main heat generation source in a signal reception substrate 31 and generates heat. The amount of heat generated by the signal reception substrate 31 is smaller than that of the LED substrate 8 (heat generation amount: medium). In a control substrate 32 that performs image processing, a system on a chip (SoC) is a main heat generation source and generates heat. The amount of heat generated by the control substrate 32 is smaller than that of the LED substrate 8 (heat generation amount: medium). The heat generation amount of the LEDs 8a varies depending on the illumination intensity of the LED 8a. Therefore, the magnitude relationship between the heat generation amount of the SoC and the heat generation amount of the LEDs 8a may be reversed.

Next, heat transfer in the camera head 2 will be described. FIG. 14 is an explanatory diagram illustrating heat transfer in the camera head 2. As illustrated in FIG. 14, in the camera head 2, the LEDs 8a are heat sources in the LED substrate 8. The heat of the LED substrate 8 is released from the copper pattern 8c to the air inside the LED cover 7 by convection and radiation. Further, the heat of the LED substrate 8 is transferred to the front case 9 and is released from the heat sink 9b to the outside of the camera head 2 (A in the drawing). The heat of the LED substrate 8 is reflected by the partition wall portion 15e through the air layer 15g. The heat reflected by the partition wall portion 15e is released from the heat sink 9b to the outside of the camera head 2 (the atmosphere) (B in the drawing). The imaging element 19a is a heat source in the sensor substrate 19. The heat of the sensor substrate 19 is released from the copper pattern 19e to the air inside the lens unit case 15 by convection and radiation. The heat of the sensor substrate 19 is also transferred from the lens unit case 15 to the bracket 6 and is released to the outside of the camera head 2 (the atmosphere) (C in the drawing).

The Ser 20a, the DC/DC converter 20b, and the LDO regulator 20c are heat sources in the signal transmission substrate 20. The heat of the signal transmission substrate 20 is released from the copper pattern 20f to the air inside the rear case 12 by convection and radiation, and is released from the heat sink 12a to the outside of the camera head 2 (the atmosphere) (D in the drawing). Further, the heat of the signal transmission substrate 20 is transferred to the camera control unit 3, which is an external device, via the cable 4, and is released from the camera control unit 3 to the atmosphere.

A power source driver 21b is a heat source in the LED driver substrate 21. The heat of the LED driver substrate 21 is transferred to the protruding portion 12b via the heat transfer sheet 25 and the metal member 24, and is released from the heat sink 12a to the outside of the camera head 2 (the atmosphere) by convection and radiation (E in the drawing).

In the camera control unit 3, a deserializer (Des) 31a is a heat source in the signal reception substrate 31. A Soc 32a is a heat source in the control substrate 32. The heat of the signal reception substrate 31 and the control substrate 32 is released from the camera control unit 3 to the atmosphere (F and G in the drawing).

As described above, according to the first embodiment, it is possible to achieve both improvement in heat dissipation effect and downsizing of the camera head 2.

### Second Embodiment

The present invention can be applied, not only to the camera head 2 described in the first embodiment, but also to a camera head 100 in which the LED substrate 8 is not provided. The camera head 100 according to the second embodiment is characterized in that the camera head 100 includes one housing 101 that accommodates the lens unit 14, the sensor substrate 19, and the signal transmission substrate 20, and does not include the LED substrate 8 and the LED cover 7. Main features of the camera head 100 will be described below, and the same components as those in the first embodiment will be denoted by the same reference signs, and the description thereof will be omitted.

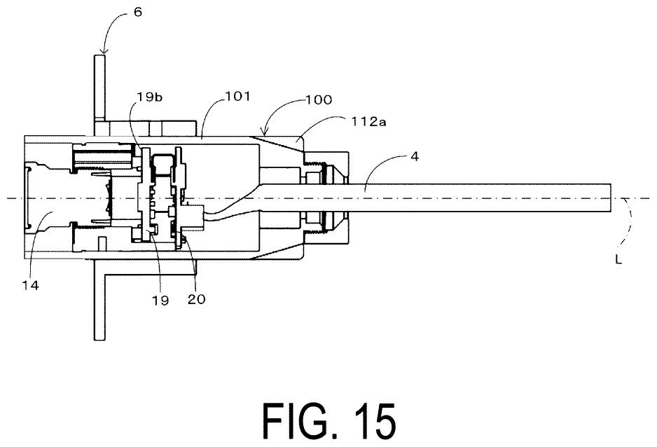

FIG. 15 is a longitudinal cross-sectional view of the camera head 100 according to the second embodiment. As illustrated in FIG. 15, the camera head 100 according to the second embodiment includes the housing 101 having a cylindrical shape. The housing 101 accommodates the lens unit 14, the sensor substrate 19, and the signal transmission substrate 20. The housing 101 includes, at a rear end portion thereof, a heat sink 112a.

The sensor substrate 19 and the signal transmission substrate 20 are retained at a predetermined interval by the spacer member 15c and the positioning member 15d, as in FIGS. 4 to 7. The sensor mounting surface 19b of the sensor substrate 19 is in thermal contact with the housing 101. Specifically, the copper pattern 19e of the sensor mounting surface 19b and the housing 101 are in physical contact with each other. On the other hand, the signal transmission substrate 20 is separated from the housing 101. As illustrated in FIG. 15, the sensor substrate 19 is disposed substantially at the center of the housing 101, and partitions the space inside the housing 101 in the optical axis direction. Therefore, the air inside the housing 101 hardly circulates between a space inside the housing 101 formed on the front side of the sensor substrate 19 and a space inside the housing 101 formed on the rear side of the sensor substrate 19. That is, the camera head 100 has a configuration in which the heat generated on the rear side of the sensor substrate 19 is less likely to be transferred to the front side of the sensor substrate 19.

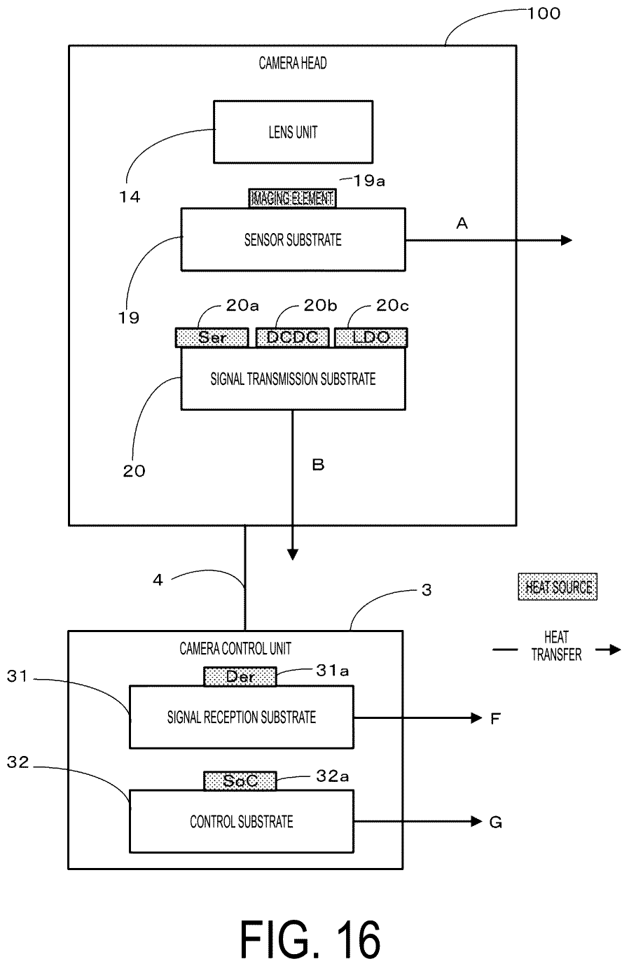

Next, heat transfer in the camera head 100 will be described. FIG. 16 is an explanatory diagram illustrating heat transfer of the camera head 100 according to the second embodiment. As illustrated in FIG. 16, the heat of the sensor substrate 19 is transferred to the housing 101 and is released from the housing 101 to the outside of the camera head 100 (the atmosphere) (A in the drawing). The heat is also released from the housing 101 to the outside of the camera head 100 via the bracket 6. The heat of the signal transmission substrate 20 is released to the outside of the camera head 100 (the atmosphere) via the heat sink 112a by radiation (B in the drawing). Further, the heat of the signal transmission substrate 20 is transferred to the camera control unit 3, which is an external device, via the cable 4, and is released from the camera control unit 3 to the outside (the atmosphere). Since the sensor substrate 19 partitions the space inside the housing 101 in the optical axis direction (see FIG. 15), the heat of the signal transmission substrate 20 is hardly transferred to the lens unit 14 and the imaging element 19a.

The heat of the signal reception substrate 31 and the control substrate 32 is released from the camera control unit 3 to the atmosphere (F and G in the drawing) as in the first embodiment.

In the second embodiment, the sensor substrate 19 and the signal transmission substrate 20 are not formed as one collective substrate. The sensor substrate 19 and the signal transmission substrate 20 are arranged along the optical axis L. The in-plane direction of the sensor substrate 19 and the in-plane direction of the signal transmission substrate 20 are orthogonal to the optical axis direction. This configuration can reduce the size of the camera head 100. The sensor substrate 19 and the signal transmission substrate 20 are disposed with a gap therebetween. Accordingly, the heat dissipation efficiency is increased. Thus, the camera head 100 according to the second embodiment can achieve both downsizing and improvement in heat dissipation efficiency.

### Third Embodiment

Next, a camera head 200 according to a third embodiment will be described. The camera head 200 has a configuration in which the LED substrate 8 and the LED cover 7 are not provided as in the camera head 100. However, the camera head 200 differs in housing structure from the camera head 100. Note that the same components as those in the first and second embodiments are denoted by the same reference signs, and description thereof are omitted.

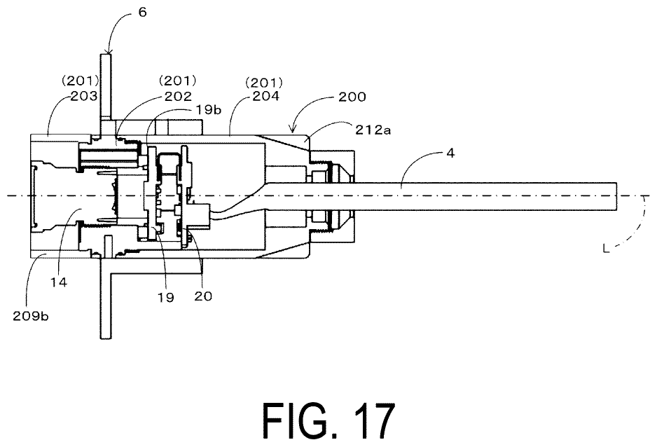

FIG. 17 is a longitudinal cross-sectional view of the camera head 200 according to the third embodiment. As illustrated in FIG. 17, the camera head 200 includes an imaging unit 202, a front case 203 provided on the front side of the imaging unit 202, and a rear case 204 provided on the rear side of the imaging unit 202. The imaging unit 202 retains a rear portion of the lens unit 14 by screwing. The front case 203 is connected to the imaging unit 202 and accommodates a front portion of the lens unit 14, that is, a portion exposed on the front side of the imaging unit 202. The rear case 204 accommodates the sensor substrate 19 and the signal transmission substrate 20. A housing 201 includes the front case 203, the imaging unit 202, and the rear case 204. The housing 201 has a cylindrical shape as a whole.

The front case 203 is connected to the imaging unit 202 by a connection method with a high thermal resistance. The rear case 204 is connected to the imaging unit 202 by a connection method with a high thermal resistance. The connection method with a high thermal resistance is, for example, connection by screwing with a small contact area, connection via a member having a low thermal conductivity (e.g., resin), or connection via an adhesive.

One or both of the front case 203 and the rear case 204 are connected to an external member (e.g., the bracket 6). That is, the camera head 200 has a configuration in which heat can be transferred from the front case 203 or the rear case 204 to a member outside the camera head 200. In addition, a means for releasing heat (e.g., a heat sink 209b or a heat sink 212a) to the outside of the camera head 200 (e.g., the atmosphere) is provided at one or both of the front case 203 and the rear case 204.

The sensor substrate 19 is retained at a position separated at a predetermined interval from the signal transmission substrate 20 by the spacer member 15c and the positioning member 15d, as in FIGS. 4 to 7.

The sensor mounting surface 19b of the sensor substrate 19 is in contact with the housing 201 (specifically, the imaging unit 202) and is further in thermal contact with the housing 201. On the other hand, the signal transmission substrate 20 is separated from the housing 201.

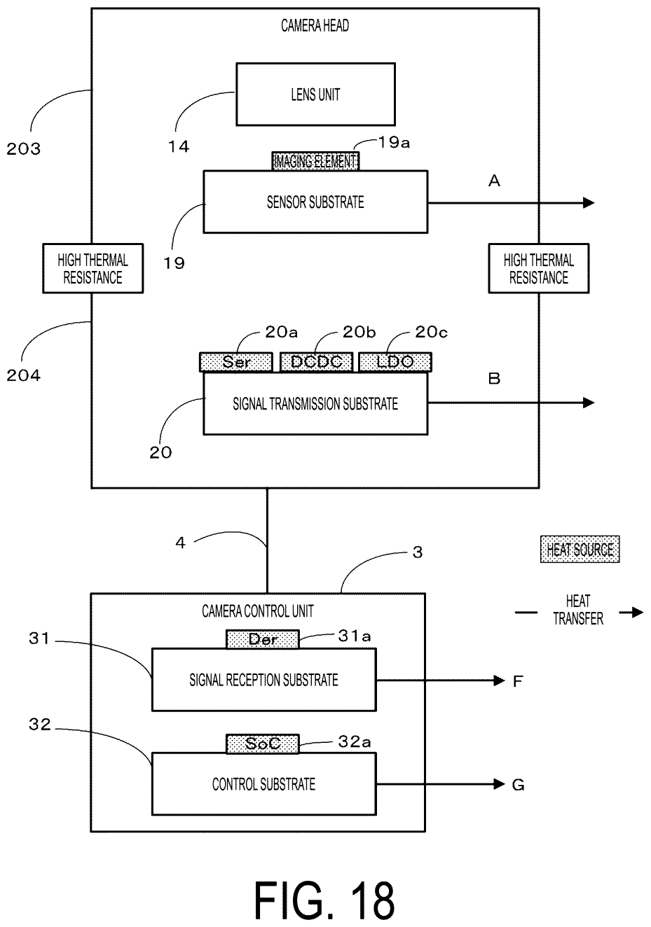

Next, heat transfer in the camera head 200 will be described. FIG. 18 is an explanatory diagram illustrating heat transfer of the camera head 200 according to the third embodiment. As illustrated in FIG. 18, the heat of the sensor substrate 19 is released to the outside of the camera head 200 (the atmosphere) via the front case 203 (A in the drawing). The heat of the signal transmission substrate 20 is released to the outside of the camera head 200 (the atmosphere) via the rear case 204 (B in the drawing). Further, the heat of the signal transmission substrate 20 is transferred to the camera control unit 3, which is an external device, via the cable 4, and is released from the camera control unit 3 to the outside (the atmosphere). The heat of the signal reception substrate 31 and the control substrate 32 is released from the camera control unit 3 to the atmosphere (F and G in the drawing) as in the first and second embodiments.

According to the third embodiment, in the camera head 200, it is possible to achieve both improvement in heat dissipation effect and downsizing of the camera as in the first or second embodiment.

### Modifications

In the above-described embodiments, examples in which the sensor substrate 19, the signal transmission substrate 20, and the LED driver substrate 21 are formed as single-layer substrates have been described, but any or all of the sensor substrate 19, the signal transmission substrate 20, and the LED driver substrate 21 may be multi-layer substrates.

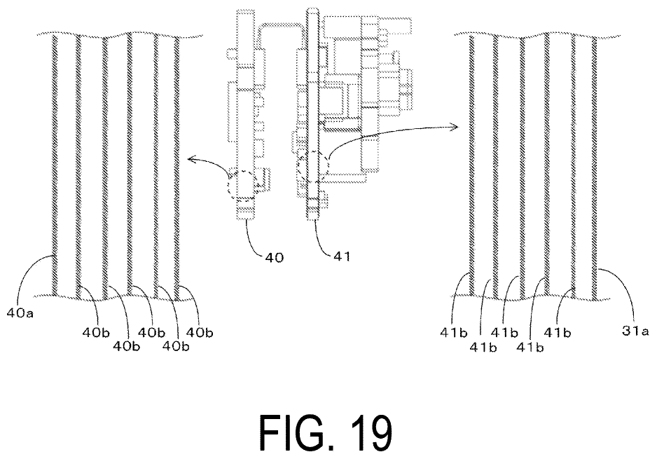

FIG. 19 illustrates a sensor substrate and a signal transmission substrate according to a modification. For example, as illustrated in FIG. 19, a sensor substrate 40 having a multilayer structure includes a sensor mounting surface 40a. The substrate includes a heat dissipation layer 40b formed of a copper pattern which is a copper foil. Accordingly, the thermal conductivity can be increased to efficiently dissipate heat.

The signal transmission substrate 41 having a multilayer structure includes a module mounting surface 41a. The substrate includes a heat dissipation layer 41b formed of a copper pattern which is a copper foil. Accordingly, the thermal conductivity can be increased to efficiently dissipate heat.

Although various embodiments have been described above with reference to the drawings, it goes without saying that the present disclosure is not limited to such examples. A person skilled in the art can conceive of various changes, modifications, substitutions, additions, deletions, and equivalents within the scope described in the claims, and it should be understood that these also naturally fall within the technical scope of the present disclosure. The components in the various embodiments described above may be combined as desired to an extent that does not depart from the scope of the invention.

The present disclosure includes the following inventions.

### Invention 1A

An imaging device including: an imaging element; a lens unit configured to guide light to the imaging element; a front case accommodating the lens unit; and a partition wall portion extending along an optical axis direction in a space between the lens unit and the front case, and partitioning the space in a radial direction.

### Invention 1B

The imaging device according to Invention 1A above, including a heat dissipation portion provided on an outer circumferential surface of the front case, in which the heat dissipation portion includes at least one of a fin portion and a hole portion.

### Invention 1C

The imaging device according to Invention 1B above, in which the heat dissipation portion includes at least the hole portion, the hole portion has at least one of a slit shape, a mesh shape, or a punch hole shape, and air inside the front case is ventilated through the hole portion.

### Invention 1D

The imaging device according to Invention 1A above, including a light source configured to illuminate the front of the lens unit, in which the light source is in thermal contact with the front case.

### Invention 1E

The imaging device according to Invention 1D above, in which the light source includes a plurality of light emitting elements, an element substrate having the plurality of light emitting elements mounted thereon, and a heat transfer pattern through which heat of the element substrate is released, the heat transfer pattern being provided on a mounting surface of the element substrate on which the plurality of light emitting elements are mounted.

### Invention 1F

The imaging device according to Invention 1E above, including a heat dissipation portion provided on an outer circumferential surface of the front case, in which the front case includes a contact surface in contact with the heat transfer pattern at an end portion on a side to which light is incident in the optical axis direction, and the heat of the element substrate is transferred from the heat transfer pattern to the heat dissipation portion via the contact surface.

### Invention 1G

The imaging device according to Invention 1F above, including a lens unit case retaining the lens unit, in which the front case and the lens unit case are connected via a heat insulating member.

### Invention 1H

The imaging device according to Invention 1C above, in which an entirety of the hole portion has the slit shape, and the slit shape extends in a circumferential direction of the front case.

### Invention 1I

The imaging device according to Invention 1A above, including a heat dissipation portion provided on an outer circumferential surface of the front case, and a light source configured to illuminate the front of the lens unit, in which the light source is in thermal contact with the front case, the heat dissipation portion includes a hole portion provided in a circumferential direction of the front case, and the light source includes a light emitting portion provided at a position overlapping the hole portion when the front case is viewed from the optical axis direction.

### Invention 1J

The imaging device according to Invention 1E above, including a drive substrate including a drive unit configured to drive the plurality of light emitting elements, in which the drive substrate is provided downstream of the element substrate in a travel direction of the light in the optical axis direction.

### Invention 1K

The imaging device according to Invention 1A above, in which the partition wall portion is a cylinder made of a metal material, and a surface of the partition wall portion is not coated.

### Invention 2A

An imaging device including: an imaging element; a lens unit configured to guide light to the imaging element; a processing module configured to process an output signal of the imaging element; and a housing accommodating the imaging element, the lens unit, and the processing module, in which the housing includes a heat dissipation portion provided downstream of the lens unit in a travel direction of light traveling from the lens unit toward the imaging element, the heat dissipation portion includes a plurality of fins provided on an outer circumferential surface of the housing, and a protruding portion provided on an inner circumferential surface of the housing, and the processing module is in thermal contact with the protruding portion.

### Invention 2B

The imaging device according to Invention 2A above, in which the processing module is disposed downstream of the imaging element in the travel direction of the light.

### Invention 2C

The imaging device according to Invention 2B above, in which the processing module is in thermal contact with the protruding portion via a heat transfer portion.

### Invention 2D

The imaging device according to Invention 2C above, in which the housing includes a lens unit case accommodating the lens unit, and a rear case accommodating the imaging element and the processing module, and the heat transfer portion is slidable with the protruding portion when the rear case is attached to the lens unit case.

### Invention 2E

The imaging device according to Invention 2D above, in which the lens unit case is screwed to the rear case, and the heat transfer portion is slidable with the protruding portion in a circumferential direction when the lens unit is rotated relative to the rear case.

### Invention 2F

The imaging device according to Invention 2E above, in which the heat transfer portion includes a metal member that slides with the protruding portion, and a heat transfer member having an insulating property and in contact with the processing module.

### Invention 2G

The imaging device according to Invention 2A above, in which the processing module is connected to an external device via a cable.

### Invention 2H

The imaging device according to Invention 2A above, in which the housing has a cylindrical shape in its entirety, and the plurality of fins has a shape not protruding from an outer circumferential surface of the housing when viewed from an optical axis direction.

### Invention 2I

The imaging device according to Invention 2A above, in which each of the plurality of fins has at least either a shape extending parallel to an optical axis direction or a shape extending in a direction intersecting the optical axis direction.

### INDUSTRIAL APPLICABILITY

The present disclosure is useful as an imaging device that achieves both improvement in heat dissipation efficiency and downsizing.

### REFERENCE SIGNS LIST

2 Camera head (imaging device)
3 Camera control unit (external device)
4 Cable
5 Housing
6 Bracket
7 LED cover
8 LED substrate (element substrate)
8a LED (light emitting element)
8c Copper pattern (heat transfer pattern)
9 Front case (housing)
9a Contact surface
9b Heat sink
10 Heat insulating ring (heat insulating member)
11 Imaging unit
12 Rear case (housing)
12a Heat sink (heat dissipation portion)
12b Protruding portion
12d Fin
13 FPC (flexible conductive member)
14 Lens unit
15 Lens unit case (housing)
15c Spacer member
15d Positioning member
15e Partition wall portion
15f, 15g Air layer
19 Sensor substrate (first substrate)
19a Imaging element
19b Sensor mounting surface (first mounting surface)
19c Notch (first notch portion)
19d Notch (second notch portion)
19e Copper pattern (heat transfer pattern)
20 Signal output substrate (second substrate)
20a Ser (processing module)
20b DC/DC converter (processing module)
20c LDO regulator (processing module)
20d Module mounting surface (second mounting surface)
20e Notch (third notch portion)
20f Copper pattern (heat transfer pattern)
21 LED drive substrate (drive substrate)
23 Second spacer member
23a Shaft
24 Metal member
25 Heat transfer sheet (heat transfer member)
L Optical axis

1. An imaging device comprising:
a first substrate including a first mounting surface on which an imaging element is mounted;
a second substrate including a second mounting surface on which a processing module configured to process an output signal of the imaging element is mounted;
a lens unit configured to guide light to the imaging element; and
a housing accommodating the first substrate, the second substrate, and the lens unit, wherein
the first substrate is disposed such that the first mounting surface intersects an optical axis direction,
the second substrate is disposed such that the second mounting surface intersects the optical axis direction, and a gap is present between the second substrate and the first substrate along the optical axis direction, and
the gap is maintained by a spacer member.

2. The imaging device according to claim 1, wherein the first substrate includes a heat transfer pattern through which heat generated on the first mounting surface is released.

3. The imaging device according to claim 2, wherein the heat transfer pattern is provided around the imaging element on the first mounting surface.

4. The imaging device according to claim 1, wherein
the housing includes a lens unit case retaining the lens unit, and
the lens unit case is in thermal contact with the first mounting surface.

5. The imaging device according to claim 1, comprising a flexible conductive member connecting the first substrate and the second substrate.

6. The imaging device according to claim 1, wherein a heat generation amount of the second substrate is larger than a heat generation amount of the first substrate.

7. The imaging device according to claim 1, wherein the processing module has a function of converting a parallel signal of the imaging element into a serial signal, and transmitting the serial signal.

8. The imaging device according to claim 1, comprising a cable through which a signal is output to an external device, wherein
the cable is connected to the second substrate, and
heat of the second substrate is released to an outside via the cable.

9. The imaging device according to claim 8, wherein the second mounting surface includes a connection port connecting with the cable, and a heat transfer pattern through which heat generated on the second mounting surface is released, the heat transfer pattern being provided around the connection port.

10. The imaging device according to claim 1, wherein the spacer member maintains the gap by being in contact with a surface of the second substrate on an opposite side to the second mounting surface.

11. The imaging device according to claim 10, wherein the first substrate and the second substrate have a disk shape.

12. The imaging device according to claim 11, wherein one end side of the spacer member is engaged with a first notch portion provided at a peripheral edge portion of the first substrate, and the other end side is in contact with the second substrate.

13. The imaging device according to claim 12, comprising a positioning member positioning the second substrate relative to the first substrate in a circumferential direction, wherein
the positioning member engages with a second notch portion provided at a peripheral edge portion of the first substrate and a third notch portion provided at a peripheral edge portion of the second substrate.

14. The imaging device according to claim 1, comprising a bracket retaining the housing, wherein
the bracket is in thermal contact with the housing.

15. The imaging device according to claim 1, wherein the first substrate and the second substrate are disposed such that a surface of the first substrate on an opposite side to the first mounting surface, and a surface of the second substrate on an opposite side to the second mounting surface face each other.

16. The imaging device according to claim 1, wherein the spacer member restricts rotation of the first substrate about the optical axis direction by engaging with the first substrate.
